(19) United States
(12) Patent Application Publication
(10) Pub. No.: US 2025/0358677 A1
(43) Pub. Date: Nov. 20, 2025

(54) METHOD AND APPARATUS FOR ENHANCED PACKET DISCARDING IN WIRELESS COMMUNICATION SYSTEM

(71) Applicant: Samsung Electronics Co., Ltd., Suwon-si, Gyeonggi-do (KR)

(72) Inventors: Anil AGIWAL, Suwon-si (KR); Hyunjeong KANG, Suwon-si (KR); Taeseop LEE, Suwon-si (KR)

(21) Appl. No.: 18/871,689

(22) PCT Filed: Jun. 2, 2023
(86) PCT No.: PCT/KR2023/007648

§ 371 Date: Dec. 4, 2024

(30) Foreign Application Priority Data
Jun. 8, 2022 (KR) 10-2022-0069707
Jun. 16, 2022 (KR) 10-2022-0073791

(51) Int. Cl. H04W 28/06; H04W 8/22; H04W 76/20

(52) U.S. Cl. CPC H04W 28/06; H04W 8/22; H04W 76/20

(57) ABSTRACT

The disclosure relates to a 5G or 6G communication system for supporting a higher data transmission rate. Specifically, the present disclosure provides a method and an apparatus for enhanced packet discarding. Also, the present disclosure provides a method and an apparatus for logical channel prioritization.

### TECHNICAL FIELD

The disclosure relates to a wireless communication system (or a mobile communication system). Specifically, the disclosure relates to an apparatus, a method and a system for enhanced packet discarding in wireless communication system. Also, the disclosure relates to an apparatus, a method and a system for logical channel prioritization in wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

Recently, there are needs to enhance packet discarding procedure in wireless communication system. Also, there are also needs to enhance logical channel prioritization in wireless communication system.

### DISCLOSURE OF INVENTION

### Solution to Problem

Aspects of the disclosure are to address at least the above-mentioned problems and/or disadvantages and to provide at least the advantages described below. Accordingly, an aspect of the disclosure is to provide a communication method and system for converging a fifth generation (5G) communication system for supporting higher data rates beyond a fourth generation (4G).

In accordance with an aspect of the disclosure, a method performed by a terminal is provided. The method comprises: receiving, from a base station, information on an application frame discarding for a data radio bearer (DRB) which is associated with an extended reality (XR) application and configured with a discard timer; obtaining, by a packet data convergence protocol (PDCP) layer from an upper layer, a PDCP service data unit (SDU) with application frame information; and applying the application frame discarding for the PDCP SDU based on the information and the application frame information.

In accordance with another aspect of the disclosure, a terminal is provided. The terminal comprises: a transceiver; and a controller coupled with the transceiver and configured to: receive, from a base station, information on an application frame discarding for a data radio bearer (DRB) which is associated with an extended reality (XR) application and configured with a discard timer, obtain, by a packet data convergence protocol (PDCP) layer from an upper layer, a PDCP service data unit (SDU) with application frame information, and apply the application frame discarding for the PDCP SDU based on the information and the application frame information.

In accordance with another aspect of the disclosure, a method performed by a base station is provided. The method comprises: transmitting, to a terminal, information on an application frame discarding for a data radio bearer (DRB) which is associated with an extended reality (XR) application and configured with a discard timer, wherein the application frame discarding is applied for a packet data convergence protocol (PDCP) service data unit (SDU) obtained with application frame information, based on the information and the application frame information.

In accordance with another aspect of the disclosure, a base station is provided. The base station comprises: a transceiver; and a controller coupled with the transceiver and configured to: transmit, to a terminal, information on an application frame discarding for a data radio bearer (DRB) which is associated with an extended reality (XR) application and configured with a discard timer, wherein the application frame discarding is applied for a packet data convergence protocol (PDCP) service data unit (SDU) obtained with application frame information, based on the information and the application frame information.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a protocol stack for user plane in accordance with an embodiment of the disclosure.

FIG. 2 illustrates an example of data flow in accordance with an embodiment of the disclosure.

FIG. 3 illustrates an example of a flow chart for enhanced packet discarding between user equipment (UE) and next generation node B (gNB) in accordance with an embodiment of the disclosure.

FIG. 4 illustrates another example of a flow chart for enhanced packet discarding between UE and gNB in accordance with an embodiment of the disclosure.

FIG. 5 illustrates another example of a flow chart for enhanced packet discarding between UE and gNB in accordance with an embodiment of the disclosure.

FIG. 6 illustrates another example of a flow chart for enhanced packet discarding in accordance with an embodiment of the disclosure.

FIG. 7 illustrates an example of a flow chart for logical channel prioritization in accordance with an embodiment of the disclosure.

FIG. 8 illustrates another example of a flow chart for logical channel prioritization in accordance with an embodiment of the disclosure.

FIG. 9 illustrates another example of a flow chart for logical channel prioritization in accordance with an embodiment of the disclosure.

FIG. 10 is a block diagram of a terminal according to an embodiment of the disclosure.

FIG. 11 is a block diagram of a base station according to an embodiment of the disclosure.

Throughout the drawings, like reference numerals will be understood to refer to like parts, components, and structures.

### BEST MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5GNB), or gNB.

The “UE” is an entity communicating with a BS and may be referred to as UE, device, mobile station (MS), mobile equipment (ME), or terminal.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analysing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described big data processing technology may also be considered to be as an example of convergence between the 5G technology and the IoT technology.

Radio Resource Control (RRC) states in fifth generation wireless communication system: In the fifth generation wireless communication system, RRC can be in one of the following states: RRC_IDLE, RRC_INACTIVE, and RRC_CONNECTED. A UE is either in RRC_CONNECTED state or in RRC_INACTIVE state when an RRC connection has been established. If this is not the case, i.e. no RRC connection is established, the UE is in RRC_IDLE state. The RRC states can further be characterized as follows:

In the RRC_IDLE, a UE specific discontinuous (DRX) may be configured by upper layers. The UE monitors Short Messages transmitted with paging radio network temporary identifier (P-RNTI) over downlink control information (DCI); monitors a Paging channel for core network (CN) paging using 5G-S-temoprary mobile subscriber identity (5G-S-TMSI); performs neighboring cell measurements and cell (re-)selection; acquires system information and can send SI request (if configured); performs logging of available measurements together with location and time for logged measurement configured UEs.

In RRC_INACTIVE, a UE specific DRX may be configured by upper layers or by RRC layer; UE stores the UE Inactive access stratum (AS) context; a RAN-based notification area is configured by RRC layer. The UE monitors Short Messages transmitted with P-RNTI over DCI; monitors a Paging channel for CN paging using 5G-S-TMSI and RAN paging using fullI-RNTI; performs neighbouring cell measurements and cell (re-)selection; performs RAN-based notification area updates periodically and when moving outside the configured RAN-based notification area; acquires system information and can send SI request (if configured); performs logging of available measurements together with location and time for logged measurement configured UEs.

In the RRC_CONNECTED, the UE stores the AS context and transfer of unicast data to/from UE takes place. The UE monitors Short Messages transmitted with P-RNTI over DCI, if configured; monitors control channels associated with the shared data channel to determine if data is scheduled for it; provides channel quality and feedback information; performs neighbouring cell measurements and measurement reporting; acquires system information.

Carrier Aggregation (CA)/Multi-connectivity in fifth generation wireless communication system: The fifth generation wireless communication system, supports standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports MultiRAT Dual Connectivity (MR-DC) operation whereby a UE in RRC_CONNECTED is configured to utilize radio resources provided by two distinct schedulers, located in two different nodes connected via a non-ideal backhaul and providing either Evolved Universal Terrestrial Radio Access (E-UTRA) (i.e., if the node is an ng-eNB) or NR access (i.e., if the node is a gNB). In NR for a UE in RRC_CONNECTED not configured with CA/DC there is only one serving cell comprising of the primary cell. For a UE in RRC_CONNECTED configured with CA/DC the term ‘serving cells’ is used to denote the set of cells comprising of the Special Cell(s) and all secondary cells. In NR the term Master Cell Group (MCG) refers to a group of serving cells associated with the Master Node, comprising of the Primary Cell (PCell) and optionally one or more Secondary Cells (SCells). In NR the term Secondary Cell Group (SCG) refers to a group of serving cells associated with the Secondary Node, comprising of the Primary SCG Cell (PSCell) and optionally one or more SCells. In NR PCell refers to a serving cell in MCG, operating on the primary frequency, in which the UE either performs the initial connection establishment procedure or initiates the connection re-establishment procedure. In NR for a UE configured with CA, SCell is a cell providing additional radio resources on top of Special Cell. PSCell refers to a serving cell in SCG in which the UE performs random access when performing the Reconfiguration with Sync procedure. For Dual Connectivity operation the term SpCell (i.e., Special Cell) refers to the PCell of the MCG or the PSCell of the SCG, otherwise the term Special Cell refers to the PCell.

Random access in fifth generation wireless communication system: In the 5G wireless communication system, random access (RA) is supported. Random access (RA) is used to achieve uplink (UL) time synchronization. RA is used during initial access, handover, RRC connection re-establishment procedure, scheduling request transmission, SCG addition/modification, beam failure recovery and data or control information transmission in UL by non-synchronized UE in RRC CONNECTED state. Several types of random access procedure is supported such as contention based random access, contention free random access and each of these can be one 2 step or 4 step random access.

BWP operation in fifth generation wireless communication system: In fifth generation wireless communication system bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring RRC connected UE with BWP(s) and telling the UE which of the configured BWPs is currently the active one. When BA is configured, the UE only has to monitor physical downlink control channel (PDCCH) on the one active BWP i.e., it does not have to monitor PDCCH on the entire downlink (DL) frequency of the serving cell. In RRC connected state, UE is configured with one or more DL and UL BWPs, for each configured Serving Cell (i.e., PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the medium access control (MAC) entity itself upon initiation of RA procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

PDCCH in fifth generation wireless communication system: In the fifth generation wireless communication system, PDCCH is used to schedule DL transmissions on physical downlink shared channel (PDSCH) and UL transmissions on physical uplink shared channel (PUSCH), where the DCI on PDCCH includes: Downlink assignments containing at least modulation and coding format, resource allocation, and hybrid-automatic repeat request (ARQ) information related to downlink shared channel (DL-SCH); Uplink scheduling grants containing at least modulation and coding format, resource allocation, and hybrid-ARQ information related to uplink shared channel (UL-SCH). In addition to scheduling, PDCCH can be used to for: Activation and deactivation of configured PUSCH transmission with configured grant; Activation and deactivation of physical downlink shared channel (PDSCH) semi-persistent transmission; Notifying one or more UEs of the slot format; Notifying one or more UEs of the physical resource block (s) (PRB(s)) and orthogonal frequency division multiplexing (OFDM) symbol(s) where the UE may assume no transmission is intended for the UE; Transmission of transmission power control (TPC) commands for physical uplink control channel (PUCCH) and PUSCH; Transmission of one or more TPC commands for sounding reference signal (SRS) transmissions by one or more UEs; Switching a UE's active bandwidth part; Initiating a random access procedure. A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own demodulation reference signal (DMRS). Quadrature phase shift keying (QPSK) modulation is used for PDCCH.

In fifth generation wireless communication system, a list of search space configurations is signaled by GNB for each configured BWP of serving cell wherein each search configuration is uniquely identified by a search space identifier. Search space identifier is unique amongst the BWPs of a serving cell. Identifier of search space configuration to be used for specific purpose such as paging reception, SI reception, random access response reception is explicitly signaled by gNB for each configured BWP. In NR search space configuration comprises of parameters Monitoring-periodicity-PDCCH-slot, Monitoring-offset-PDCCH-slot, Monitoringsymbols-PDCCH-within-slot and duration. A UE determines PDCCH monitoring occasion (s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation 1 below:

(y*(number of slots in a radio frame)+x−Monitoring-offset-PDCCH-slot)mod(Monitoring-periodicity-PDCCH-slot)=0 [Equation 1]

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. search space configuration includes the identifier of coreset configuration associated with it. A list of coreset configurations is signaled by GNB for each configured BWP of serving cell wherein each coreset configuration is uniquely identified by an coreset identifier. Coreset identifier is unique amongst the BWPs of a serving cell. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported SCS is pre-defined in NR. Each coreset configuration is associated with a list of TCI (Transmission configuration indicator) states. One DL reference signal (RS) ID (synchronization signal block (SSB) or channel state information reference signal (CSI-RS)) is configured per TCI state. The list of TCI states corresponding to a coreset configuration is signaled by gNB via RRC signaling. One of the TCI state in TCI state list is activated and indicated to UE by gNB. TCI state indicates the DL TX beam (DL TX beam is quasi collocated (QCLed) with SSB/CSI-RS of TCI state) used by GNB for transmission of PDCCH in the PDCCH monitoring occasions of a search space.

Downlink scheduling in fifth generation wireless communication system: In the downlink, the gNB can dynamically allocate resources to UEs via the cell radio network temporary identifier (C-RNTI) on PDCCH(s). A UE always monitors the PDCCH(s) in order to find possible assignments when its downlink reception is enabled (activity governed by DRX when configured). When CA is configured, the same C-RNTI applies to all serving cells.

The gNB may pre-empt an ongoing PDSCH transmission to one UE with a latency-critical transmission to another UE. The gNB can configure UEs to monitor interrupted transmission indications using interruption radio network temporary identifier (INT-RNTI) on a PDCCH. If a UE receives the interrupted transmission indication, the UE may assume that no useful information to that UE was carried by the resource elements included in the indication, even if some of those resource elements were already scheduled to this UE.

In addition, with Semi-Persistent Scheduling (SPS), the gNB can allocate downlink resources for the initial HARQ transmissions to UEs: RRC defines the periodicity of the configured downlink assignments while PDCCH addressed to configured scheduling radio network temporary identifier (CS-RNTI) can either signal and activate the configured downlink assignment, or deactivate it; i.e. a PDCCH addressed to CS-RNTI indicates that the downlink assignment can be implicitly reused according to the periodicity defined by RRC, until deactivated. When required, retransmissions are explicitly scheduled on PDCCH(s).

The dynamically allocated downlink reception overrides the configured downlink assignment in the same serving cell, if they overlap in time. Otherwise a downlink reception according to the configured downlink assignment is assumed, if activated. The UE may be configured with up to 8 active configured downlink assignments for a given BWP of a serving cell. When more than one is configured:
The network decides which of these configured downlink assignments are active at a time (including all of them); and
Each configured downlink assignment is activated separately using a DCI command and deactivation of configured downlink assignments is done using a DCI command, which can either deactivate a single configured downlink assignment or multiple configured downlink assignments jointly.

Uplink scheduling in fifth generation wireless communication system: In the uplink, the gNB can dynamically allocate resources to UEs via the C-RNTI on PDCCH(s). A UE always monitors the PDCCH(s) in order to find possible grants for uplink transmission when its downlink reception is enabled (activity governed by DRX when configured). When CA is configured, the same C-RNTI applies to all serving cells.

The gNB may cancel a PUSCH transmission, or a repetition of a PUSCH transmission, or an SRS transmission of a UE for another UE with a latency-critical transmission. The gNB can configure UEs to monitor cancelled transmission indications using CI-RNTI on a PDCCH. If a UE receives the cancelled transmission indication, the UE shall cancel the PUSCH transmission from the earliest symbol overlapped with the resource or the SRS transmission overlapped with the resource indicated by cancellation. In addition, with Configured Grants, the gNB can allocate uplink resources for the initial HARQ transmissions and HARQ retransmissions to UEs. Two types of configured uplink grants are defined:
With Type 1, RRC directly provides the configured uplink grant (including the periodicity).
With Type 2, RRC defines the periodicity of the configured uplink grant while PDCCH addressed to CS-RNTI can either signal and activate the configured uplink grant, or deactivate it; i.e., a PDCCH addressed to CS-RNTI indicates that the uplink grant can be implicitly reused according to the periodicity defined by RRC, until deactivated.

If the UE is not configured with enhanced intra-UE overlapping resources prioritization, the dynamically allocated uplink transmission overrides the configured uplink grant in the same serving cell, if they overlap in time. Otherwise, an uplink transmission according to the configured uplink grant is assumed, if activated.

If the UE is configured with enhanced intra-UE overlapping resources prioritization, in case a configured uplink grant transmission overlaps in time with dynamically allocated uplink transmission or with another configured uplink grant transmission in the same serving cell, the UE prioritizes the transmission based on the comparison between the highest priority of the logical channels that have data to be transmitted and which are multiplexed or can be multiplexed in MAC protocol data units (PDUs) associated with the overlapping resources. Similarly, in case a configured uplink grant transmissions or a dynamically allocated uplink transmission overlaps in time with a scheduling request transmission, the UE prioritizes the transmission based on the comparison between the priority of the logical channel which triggered the scheduling request and the highest priority of the logical channels that have data to be transmitted and which are multiplexed or can be multiplexed in MAC PDU associated with the overlapping resource. In case the MAC PDU associated with a deprioritized transmission has already been generated, the UE keeps it stored to allow the gNB to schedule a retransmission. The UE may also be configured by the gNB to transmit the stored MAC PDU as a new transmission using a subsequent resource of the same configured uplink grant configuration when an explicit retransmission grant is not provided by the gNB.

Retransmissions other than repetitions are explicitly allocated via PDCCH(s) or via configuration of a retransmission timer.

The UE may be configured with up to 12 active configured uplink grants for a given BWP of a serving cell. When more than one is configured, the network decides which of these configured uplink grants are active at a time (including all of them). Each configured uplink grant can either be of Type 1 or Type 2. For Type 2, activation and deactivation of configured uplink grants are independent among the serving cells. When more than one Type 2 configured grant is configured, each configured grant is activated separately using a DCI command and deactivation of Type 2 configured grants is done using a DCI command, which can either deactivate a single configured grant configuration or multiple configured grant configurations jointly.

When supplementary uplink (SUL)_is configured, the network should ensure that an active configured uplink grant on SUL does not overlap in time with another active configured uplink grant on the other UL configuration.

For both dynamic grant and configured grant, for a transport block, two or more repetitions can be in one slot, or across slot boundary in consecutive available slots with each repetition in one slot. For both dynamic grant and configured grant Type 2, the number of repetitions can be also dynamically indicated in the L1 signaling. The dynamically indicated number of repetitions shall override the RRC configured number of repetitions, if both are present.

Logical channel prioritization (LCP) in fifth generation wireless communication system: In NR, the UE has an uplink rate control function which manages the sharing of uplink resources between logical channels. RRC controls the uplink rate control function by giving each logical channel a priority, a prioritized bit rate (PBR), and a buffer size duration (BSD). In addition, mapping restrictions can be configured. With LCP restrictions in MAC, RRC can restrict the mapping of a logical channel to a subset of the configured cells, numerologies, PUSCH transmission durations, configured grant configurations and control whether a logical channel can utilize the resources allocated by a Type 1 Configured Grant or whether a logical channel can utilize dynamic grants indicating a certain physical priority level. With such restrictions, it then becomes possible to reserve, for instance, the numerology with the largest subcarrier spacing and/or shortest PUSCH transmission duration for URLLC services. Furthermore, RRC can associate logical channels with different SR configurations, for instance, to provide more frequent SR opportunities to URLLC services. The uplink rate control function ensures that the UE serves the logical channel(s) in the following sequence:
1. All relevant logical channels in decreasing priority order up to their PBR;
2. All relevant logical channels in decreasing priority order for the remaining resources assigned by the grant.

In case the PBRs are all set to zero, the first step is skipped and the logical channels are served in strict priority order: the UE maximizes the transmission of higher priority data.

The mapping restrictions tell the UE which logical channels are relevant for the grant received. If no mapping restrictions are configured, all logical channels are considered.

If more than one logical channel has the same priority, the UE shall serve them equally.

### Embodiment 1—Method and Apparatus for Enhanced Packet Discarding

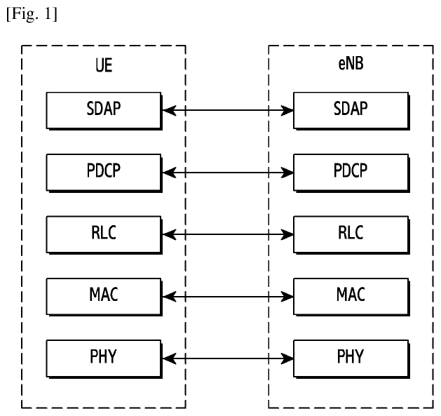

FIG. 1 illustrates a protocol stack for user plane in accordance with an embodiment of the disclosure. Radio Protocol Architecture in fifth generation wireless communication system: FIG. 1 shows the protocol stack for the user plane, consisting of service data adaptation protocol (SDAP), packet data convergence protocol (PDCP), radio link control (RLC) and MAC sublayers (terminated in gNB on the network side).

The main services and functions of the MAC sublayer include: Mapping between logical channels and transport channels; Multiplexing and demultiplexing of MAC service data units (SDUs) belonging to one or different logical channels into/from transport blocks (TB) delivered to/from the physical layer on transport channels; Scheduling information reporting; Error correction through HARQ (one HARQ entity per cell in case of CA); Priority handling between UEs by means of dynamic scheduling; Priority handling between logical channels of one UE by means of logical channel prioritization; Priority handling between overlapping resources of one UE; Padding.

The RLC sublayer supports three transmission modes: Transparent Mode (TM); Unacknowledged Mode (UM); Acknowledged Mode (AM). The main services and functions of the RLC sublayer depend on the transmission mode and include: Transfer of upper layer PDUs; Sequence numbering independent of the one in PDCP (UM and AM); Error Correction through ARQ (AM only); Segmentation (AM and UM) and resegmentation (AM only) of RLC SDUs; Reassembly of SDU (AM and UM); Duplicate Detection (AM only); RLC SDU discard (AM and UM); RLC re-establishment; Protocol error detection (AM only).

The main services and functions of the PDCP sublayer include: Transfer of data (user plane or control plane); Maintenance of PDCP sequence numbers (SNs); Header compression and decompression using the robust header compression (ROHC) protocol; Header compression and decompression using ethernet header compression (EHC) protocol; Ciphering and deciphering; Integrity protection and integrity verification; Timer based SDU discard; For split bearers, routing; Duplication; Reordering and in-order delivery; Out-of-order delivery; Duplicate discarding.

The main services and functions of SDAP include: Mapping between a quality of service (QoS) flow and a data radio bearer; Marking QoS flow ID (QFI) in both DL and UL packets. A single protocol entity of SDAP is configured for each individual PDU session.

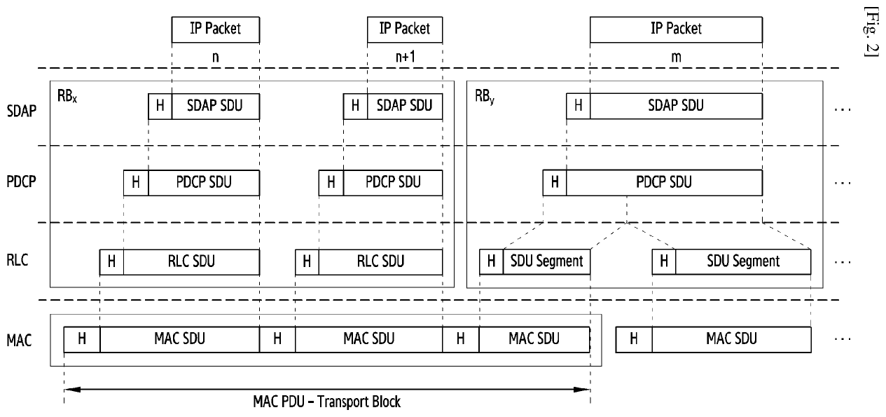

FIG. 2 illustrates an example of data flow in accordance with an embodiment of the disclosure. An example of the Data Flow is depicted in FIG. 2, where a transport block is generated by MAC by concatenating two RLC PDUs from radio bearer (RB) x and one RLC PDU from RB y. The two RLC PDUs from RB x each corresponds to one internet protocol (IP) packet (n and n+1) while the RLC PDU from RB y is a segment of an IP packet (m). H depicts the headers and subheaders.

The 5G QoS model is based on QoS Flows and supports both QoS Flows that require guaranteed flow bit rate (i.e., GBR QoS Flows) and QoS Flows that do not require guaranteed flow bit rate (i.e., non-GBR QoS Flows). At non-access stratum (NAS) level the QoS flow is thus the finest granularity of QoS differentiation in a PDU session. A QoS flow is identified within a PDU session by a QoS Flow ID (QFI) carried in an encapsulation header over NG-U.

The data radio bearer (DRB) defines the packet treatment on the radio interface (i.e., Uu interface). A DRB serves packets with the same packet forwarding treatment. The QoS flow to DRB mapping by NG-RAN is based on QFI and the associated QoS profiles (i.e., QoS parameters and QoS characteristics). Separate DRBs may be established for QoS flows requiring different packet forwarding treatment, or several QoS Flows belonging to the same PDU session can be multiplexed in the same DRB.

In the uplink, the mapping of QoS Flows to DRBs is controlled by mapping rules which are signaled in two different ways:
Reflective mapping: for each DRB, the UE monitors the QFI(s) of the downlink packets and applies the same mapping in the uplink; that is, for a DRB, the UE maps the uplink packets belonging to the QoS flows(s) corresponding to the QFI(s) and PDU Session observed in the downlink packets for that DRB. To enable this reflective mapping, the NG-RAN marks downlink packets over Uu with QFI.
Explicit Configuration: QoS flow to DRB mapping rules can be explicitly signalled by RRC.

The UE always applies the latest update of the mapping rules regardless of whether it is performed via reflecting mapping or explicit configuration. When a QoS flow to DRB mapping rule is updated, the UE sends an end marker on the old bearer. In the downlink, the QFI is signaled by NG-RAN over Uu for the purpose of reflective QoS (RQoS) and if neither NG-RAN, nor the NAS (as indicated by the RQA) intend to use reflective mapping for the QoS flow(s) carried in a DRB, no QFI is signaled for that DRB over Uu. In the uplink, NG-RAN can configure the UE to signal QFI over Uu. For each PDU session, a default DRB may be configured: if an incoming UL packet matches neither an RRC configured nor a reflective mapping rule, the UE then maps that packet to the default DRB of the PDU session. For non-GBR QoS flows, the 5GC may send to the NG-RAN the Additional QoS Flow Information parameter associated with certain QoS flows to indicate that traffic is likely to appear more often on them compared to other non-GBR QoS flows established on the same PDU session. Within each PDU session, it is up to NG-RAN how to map multiple QoS flows to a DRB. The NG-RAN may map a GBR flow and a non-GBR flow, or more than one GBR flow to the same DRB, but mechanisms to optimize these cases are not within the scope of standardization.

PDCP sub layer supports PDCP SDU discarding. At reception of a PDCP SDU from upper layers, the transmitting PDCP entity starts the discardTimer associated with this PDCP SDU (if configured). The value of discardTimer is configured by GNB using dedicated signalling. When the discardTimer expires for a PDCP SDU, or the successful delivery of a PDCP SDU is confirmed by PDCP status report, the transmitting PDCP entity shall discard the PDCP SDU along with the corresponding PDCP Data PDU. If the corresponding PDCP Data PDU has already been submitted to lower layers, the discard is indicated to lower layers.

EXtended Reality (XR) is a term for different types of realities and refers to all real-and-virtual combined environments and human-machine interactions generated by computer technology and wearables. It includes following representative forms and the areas interpolated among them: Augmented Reality (AR); Mixed Reality (MR); Virtual Reality (VR). In case of applications/services such as XR, application layer frame or data unit (also referred as PDU set) can consist of multiple IP packets. PDU set is one or more PDUs carrying the payload of one unit of information generated at the application level. If packet delay budget (PDB) exceeds for any packet/PDU of application layer frame or data unit (or PDU set), all the packets/PDUs of the frame/PDU set should be discarded to enhance the capacity. PDCP discard mechanism needs to be enhanced to enable application layer frame/data unit (or PDU set) discarding.

Network Indication for enhanced discarding (or application frame/data unit discarding):
In an embodiment of this disclosure, gNB signals an indication ‘appFrameDiscardEnabled’ or ‘appFrameDiscard’ or ‘aduDiscardEnabled’; or ‘aduDiscard’ or ‘EnhancedSDUDiscard’ or ‘PDUSetDiscard’ or ‘PDUSetDiscardEnabled’ in the dedicated signaling message to enable the enhanced discarding mechanism disclosed in this disclosure. Note that name of indication is just representative and can be referred by other names.

The dedicated signaling message can be RRC Reconfiguration message. In the signaling message, this indication can be included per DRB (or per PDCP entity), e.g., it can be included in the PDCP-Config IE of DRB configuration. GNB can set this indication for DRB(s) for which enhanced discarding is needed, e.g., for DRB(s) associated with XR application or for DRB(s) for which enhanced discarding is requested by UEs.

In an embodiment, network signal this indication if UE supports enhanced discarding. In an embodiment, UE can indicate (e.g., in UE assistance information message or any other signaling message) to gNB one or more DRB(s) for which enhanced discarding (or application frame/data unit (or PDU set) discarding) is needed; UE sends this if gNB indicates (in dedicated signaling or RRC Reconfiguration message or SI) that UE can provide assistance information for enhanced discarding (or application frame/data unit (or PDU set) discarding). UE can determine the DRB(s) associated with XR application based on information received from upper layer (e.g., upper layer can indicate QFI(s) and/or PDU session ID(s) for XR services/applications, UE can then identify corresponding to these based on DRB to QFI/PDU session mapping (explicit and/or implicit mapping as explained earlier).

In an embodiment, gNB sends the assistance information received from UE about the enhanced discarding to target gNB during the handover, so that UE does not have to send this to target gNB upon completion of handover. In case UE has send assistance information about the enhanced discarding to source gNB in the last is before the handover, UE sends the assistance information about the enhanced discarding to target gNB upon handover.

In an alternate embodiment, the indication, ‘appFrameDiscardEnabled’ or ‘appFrameDiscard’ or ‘aduDiscardEnabled’ or ‘aduDiscard’ or ‘EnhancedSDUDiscard’ or ‘AppFrameDiscardEnabled/appFrameDiscard’ or ‘aduDiscardEnabled/aduDiscard’ or ‘PDUSetDiscard’ or ‘PDUSetDiscardEnabled’ can be commonly signaled instead of per DRB.

If the indication is received, PDCP sublayer applies the enhanced discarding (or application frame/data unit (or PDU set) discarding) for DRB configured with discard timer and for which it has received ‘application layer info’ along with SDUs from upper layer. The ‘application layer info’ identifies the packets/PDUs of the same PDU set.

In an alternate embodiment, gNB can signal a list of DRB IDs for which enhanced discarding (or application frame/data unit (or PDU set) discarding) is enabled.

UE capability for enhanced discarding (or application frame/data unit (or PDU set) discarding):

UE indicates in UE capability information message whether it supports enhanced discarding (or application frame/data unit (or PDU set) discarding). UE capability information message is sent by UE to gNB in RRC_CONNECTED state. UE can send the UE capability information message upon entering RRC_CONNECTED state or upon request (e.g., upon reception of UE capability enquiry message) from gNB while the UE is in RRC_CONNECTED state.

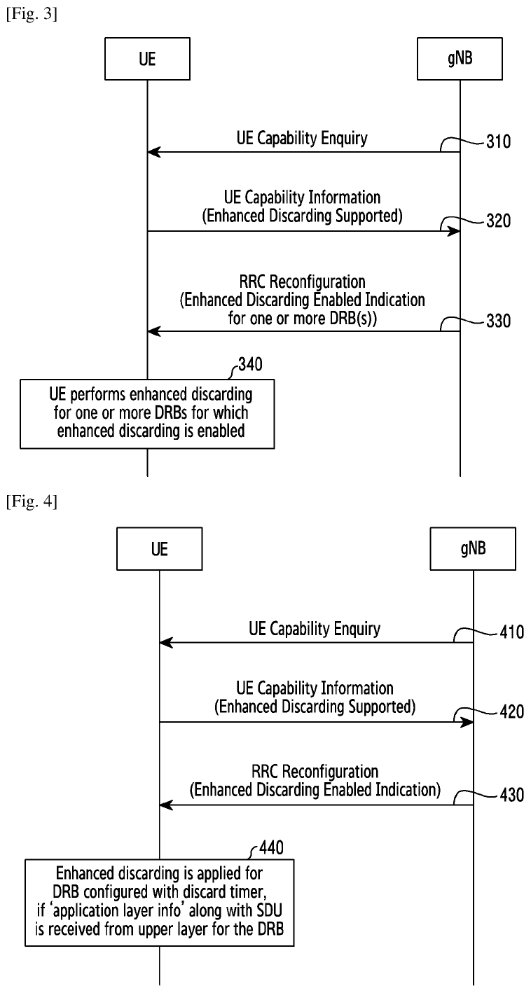

FIG. 3 illustrates an example of a flow chart for enhanced packet discarding between user equipment (UE) and next generation node B (gNB) in accordance with an embodiment of the disclosure. FIG. 3 is an example signaling flow for enhanced discarding between UE and gNB.

In step 310, gNB transmits UE capability enquiry message to UE. In step 320, UE transmits UE capability information message to gNB. The UE capability information message includes information or indication of enhanced discarding supported. In step 330, gNB transmits RRC reconfiguration message to UE. The RRC reconfiguration message includes information or indication of enhanced discarding enabled indication for one or more DRB(s). In step 340, UE performs enhanced discarding for one or more DRBs for which enhanced discarding is enabled.

FIG. 4 illustrates another example of a flow chart for enhanced packet discarding between UE and gNB in accordance with an embodiment of the disclosure. FIG. 4 is another example signaling flow for enhanced discarding between UE and gNB.

In step 410, gNB transmits UE capability enquiry message to UE. In step 420, UE transmits UE capability information message to gNB. The UE capability information message includes information or indication of enhanced discarding supported. In step 430, gNB transmits RRC reconfiguration message to UE. The RRC reconfiguration message includes information or indication of enhanced discarding enabled indication. In step 440, enhanced discarding is applied for DRB configured with discard timer, if ‘application layer information’ along with SDU is received from upper layer for the DRB.

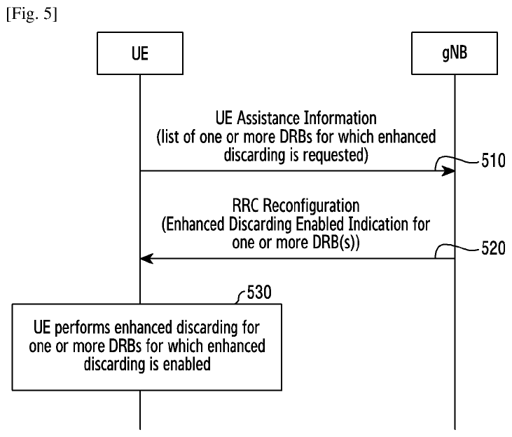

FIG. 5 illustrates another example of a flow chart for enhanced packet discarding between UE and gNB in accordance with an embodiment of the disclosure. FIG. 5 is another example signaling flow for enhanced discarding between UE and gNB.

In step 510, UE transmits UE assistance information message to gNB. The UE assistance information message includes a list of one or more DRBs for which enhanced discarding is requested. In step 520, gNB transmits RRC reconfiguration message to UE. The RRC reconfiguration message includes information or indication of enhanced discarding enabled indication for one or more DRB(s). In step 530, UE performs enhanced discarding for one or more DRBs for which enhanced discarding is enabled.

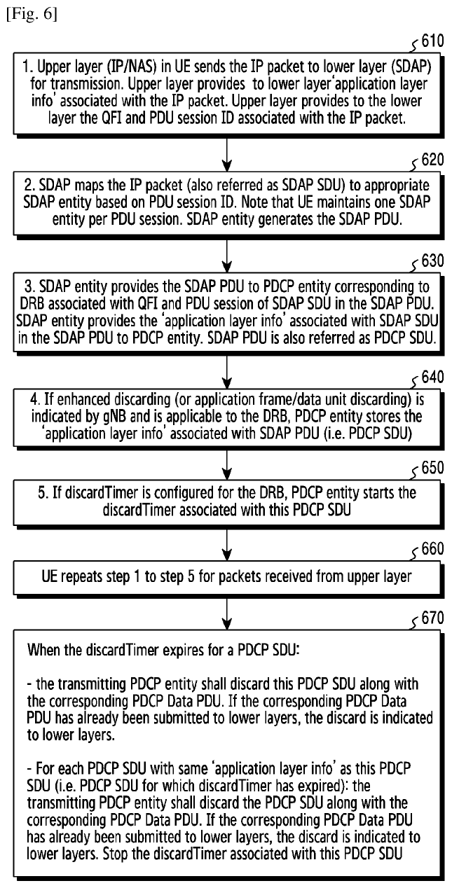

FIG. 6 illustrates another example of a flow chart for enhanced packet discarding in accordance with an embodiment of the disclosure.

### [Method 1-1, Enhanced Discarding (or Application Frame/Data Unit (or PDU Set) Discarding) Mechanism]:

In step 610, Step 1, Upper layer (e.g., IP/NAS) in UE sends the IP packet to lower layer (SDAP) for transmission. Upper layer provides to lower layer ‘application layer info’ associated with the IP packet. Upper layer provides to the lower layer the QFI and PDU session ID associated with the IP packet.

In step 620, Step 2, SDAP maps the IP packet (also referred as SDAP SDU) to appropriate SDAP entity based on PDU session ID. Note that UE maintains one SDAP entity per PDU session. SDAP entity generates the SDAP PDU.

In step 630, Step 3, SDAP entity provides the SDAP PDU to transmitting PDCP entity corresponding to DRB associated with QFI and PDU session of SDAP SDU in the SDAP PDU. SDAP entity provides the ‘application layer info’ associated with SDAP SDU in the SDAP PDU to PDCP entity. SDAP PDU is also referred as PDCP SDU.

In step 640, Step 4, If enhanced discarding (or application frame/data unit (or PDU set) discarding) is indicated by gNB and is applicable to the DRB (or PDCP entity), transmitting PDCP entity stores the ‘application layer info’ associated with SDAP PDU (i.e., PDCP SDU)

In step 650, Step 5, If discardTimer is configured for the DRB, transmitting PDCP entity starts the discardTimer associated with this PDCP SDU

In step 660, Step 6, Step 1 to step 5 is repeated for each IP packet

In step 670, Step 7, When the discardTimer expires for a PDCP SDU:
If enhanced discarding (or application frame/data unit (or PDU set) discarding) is indicated by GNB and is applicable for this DRB (or PDCP entity):
   the transmitting PDCP entity shall discard this PDCP SDU along with the corresponding PDCP Data PDU. If the corresponding PDCP Data PDU has already been submitted to lower layers, the discard is indicated to lower layers.
   For each PDCP SDU with same ‘application layer info’ (i.e. for each PDCP SDU of same PDU set) as this PDCP SDU (i.e. PDCP SDU for which discardTimer has expired) of the same DRB (in an alternate embodiment, For each PDCP SDU with same ‘application layer info’ (i.e. for each PDCP SDU of same PDU set) as this PDCP SDU (i.e. PDCP SDU for which discardTimer has expired) of the same DRB or different DRB (any DRB or amongst the list of DRBs for which enhanced discarding is applied), in case of different DRB, PDCP entity can notify other PDCP entities about the ‘application layer info’ of packet for which discard timer has expired, so that they can perform the following operation)
      the transmitting PDCP entity shall discard the PDCP SDU along with the corresponding PDCP Data PDU. If the corresponding PDCP Data PDU has already been submitted to lower layers, the discard is indicated to lower layers (we can also consider to discard in MAC in addition to RLC e.g., discard the MAC PDU/HARQ packet if it only includes the PDCP SDU to be discarded)
      Stop the discardTimer associated with this PDCP SDU
Else (i.e., if enhanced discarding (or application frame/data unit (or PDU set) discarding) is not applicable for this DRB)
   the transmitting PDCP entity shall discard this PDCP SDU along with the corresponding PDCP Data PDU. If the corresponding PDCP Data PDU has already been submitted to lower layers, the discard is indicated to lower layers.

Step 8. The ‘application layer info’ in the above description can be application layer frame info and/or application layer frame index and/or application layer data unit index/sequence number (e.g., PDU set sequence number) and/or time stamp at which application layer frame/data unit or PDU set is generated in application layer and/or application layer stream identity and/or traffic identifier. Based on this information UE can identify the packets or PDCP SDUs belonging to the same PDU set. The packets with same PDU set sequence number belongs to same PDU set.

In an embodiment, ‘application layer info’ can be there in the header of packet received from upper layer.

In an embodiment, OPTIONS field in IP packet (e.g., time stamp (TS) and IMI traffic identifier or stream ID) can be the ‘application layer info’.

In another embodiment, ‘application layer info’ need not be explicitly embedded in the packet header, it can be provided via the interface between Application layer to TCP/IP, TCP/IP to NAS, NAS to AS (e.g. SDAP).

In an embodiment, in the above procedure instead of ‘IP packet’, it can be any other protocol packet e.g., Ethernet packet, ATM packet, etc.

### [Method 1-2, Alternate Enhanced Discarding (or Application Frame/Data Unit (or PDU Set) Discarding) Mechanism (i.e., Alternate Case for Case SDAP Sublayer is not Configured or not Present in User Place Protocol Stack)]:

Step 1. Upper layer (IP/NAS) in UE sends the IP packet to lower layer (PDCP entity) for transmission. Upper layer provides to lower layer ‘application layer info’ associated with the IP packet.

Step 2. If enhanced discarding (or application frame/data unit (or PDU set) discarding) is indicated by gNB and is applicable to the DRB of the PDCP entity, transmitting PDCP entity stores the ‘application layer info’ associated with IP packet (i.e. PDCP SDU).

Step 3. If discardTimer is configured for the DRB (or PDCP entity), transmitting PDCP entity starts the discardTimer associated with this PDCP SDU

Step 4. Step 1 to step 3 is repeated for each IP packet

Step 5. When the discardTimer expires for a PDCP SDU:
If enhanced discarding (or application frame/data unit (or PDU set) discarding) is indicated by GNB and is applicable for this DRB (or PDCP entity):
   the transmitting PDCP entity shall discard this PDCP SDU along with the corresponding PDCP Data PDU. If the corresponding PDCP Data PDU has already been submitted to lower layers, the discard is indicated to lower layers.
   For each PDCP SDU with same ‘application layer info’ (i.e. for each PDCP SDU of same PDU set) as this PDCP SDU (i.e. PDCP SDU for which discardTimer has expired) of same DRB (in an alternate embodiment, For each PDCP SDU with same ‘application layer info’ (i.e. for each PDCP SDU of same PDU set) as this PDCP SDU (i.e. PDCP SDU for which discardTimer has expired) of the same DRB or different DRB (any DRB or amongst the list of DRBs for which enhanced discarding is applied), in case of different DRB, PDCP entity can notify other PDCP entities about the ‘application layer info’ (i.e. for each PDCP SDU of same PDU set) of packet for which discard timer has expired, so that they can perform the following operation)
      the transmitting PDCP entity shall discard the PDCP SDU along with the corresponding PDCP Data PDU. If the corresponding PDCP Data PDU has already been submitted to lower layers, the discard is indicated to lower layers (we can also consider to discard in MAC in addition to RLC e.g., discard the MAC PDU/HARQ packet if it only includes the PDCP SDU to be discarded)
      Stop the discardTimer associated with this PDCP SDU
Else (i.e., if enhanced discarding (or application frame/data unit (or PDU set) discarding) is not applicable for this DRB)
   the transmitting PDCP entity shall discard this PDCP SDU along with the corresponding PDCP Data PDU. If the corresponding PDCP Data PDU has already been submitted to lower layers, the discard is indicated to lower layers.

Step 6. The ‘application layer info’ in the above description can be application layer frame info and/or application layer frame index and/or application layer data unit index/sequence number (e.g., PDU set sequence number) and/or time stamp at which application layer frame/data unit or PDU set is generated in application layer and/or application layer stream identity and/or traffic identifier. Based on this information UE can identify the packets or PDCP SDUs belonging to the same PDU set. The packets with same PDU set sequence number belongs to same PDU set.

In an embodiment, ‘application layer info’ can be there in the header of packet received from upper layer.

In an embodiment, OPTIONS field in IP packet (e.g., time stamp (TS) and IMI traffic identifier or stream ID) can be the ‘application layer info’.

In another embodiment, ‘application layer info’ need not be explicitly embedded in the packet header, it can be provided via the interface between Application layer to TCP/IP, TCP/IP to NAS, NAS to AS (e.g. PDCP).

In an embodiment, in the above procedure instead of ‘IP packet’, it can be any other protocol packet e.g., Ethernet packet, ATM packet, etc.

### [Method 1-3, Alternate Enhanced Discarding (or Application Frame/Data Unit or PDU Set Discarding) Mechanism (i.e., Alternate Case)]:

Step 1. Upper layer (IP/NAS) in UE sends the IP packet to lower layer (AS) for transmission. Upper layer provides to lower layer ‘application layer info’ associated with the IP packet.

Step 2. If enhanced discarding (or application frame/data unit (or PDU set) discarding) is indicated by gNB and is applicable to the DRB to which this IP packet is mapped, AS stores the ‘application layer info’ associated with IP packet

Step 3. If discardTimer is configured for the DRB, AS starts the discardTimer associated with this IP packet

Step 4. Step 1 to step 3 is repeated for each IP packet

Step 5. When the discardTimer expires for a IP packet:
If enhanced discarding (or application frame/data unit or PDU set) discarding) is indicated by GNB and is applicable for this DRB:
   AS discard this IP packet along with the corresponding Data PDU.
   For each IP packet with same ‘application layer info’ i.e. IP packet of same PDU set as this IP packet (i.e. IP packet for which discardTimer has expired), note that IP packet may be for the same DRB as the IP packet which discard timer has expired or different DRB.
      AS discard this IP packet along with the corresponding Data PDU. Stop the discardTimer associated with this IP packet
Else (i.e. if enhanced discarding (or application frame/data unit or PDU set discarding) is not applicable for this DRB)
   AS discard this IP packet along with the corresponding Data PDU

Step 6. The ‘application layer info’ in the above description can be application layer frame info and/or application layer frame index and/or application layer data unit index/sequence number (e.g. PDU set sequence number) and/or time stamp at which application layer frame/data unit or PDU set is generated in application layer and/or application layer stream identity and/or traffic identifier. Based on this information UE can identify the packets or PDCP SDUs belonging to the same PDU set. The packets with same PDU set sequence number belongs to same PDU set.

Step 7. In an embodiment, ‘application layer info’ can be there in the header of packet received from upper layer.

In an embodiment, OPTIONS field in IP packet (e.g., time stamp (TS) and IMI traffic identifier or stream ID) can be the ‘application layer info’.

In another embodiment, ‘application layer info’ need not be explicitly embedded in the packet header, it can be provided via the interface between Application layer to TCP/IP, TCP/IP to NAS, NAS to AS.

In an embodiment, in the above procedure instead of ‘IP packet’, it can be any other protocol packet e.g., Ethernet packet, ATM packet, etc.

### [Method 1-4, Alternate Enhanced Discarding (or Application Frame/Data Unit (or PDU Set) Discarding) Mechanism (i.e., Alternate Case)]:

Step 1. Upper layer (IP/NAS) in UE sends the IP packet to lower layer (AS) for transmission. Upper layer provides to lower layer ‘application layer info’ associated with the IP packet.

Step 2. If enhanced discarding (or application frame/data unit (or PDU set) discarding) is indicated by gNB, AS stores the ‘application layer info’ associated with IP packet

Step 3. If discardTimer is configured, AS starts the discardTimer for this IP packet

Step 4. Step 1 to step 3 is repeated for each IP packet

Step 5. When the discardTimer expires for a IP packet:
If enhanced discarding (or application frame/data unit (or PDU set) discarding) is indicated by GNB and is applicable for this DRB:
   AS discard this IP packet along with the corresponding Data PDU.
   For each IP packet with same ‘application layer info’ (i.e IP packet of the same PDU set) as this IP packet (i.e., IP packet for which discardTimer has expired), note that IP packet may be for the same DRB as the IP packet which discard timer has expired or different DRB
      AS discard this IP packet along with the corresponding Data PDU. Stop the discardTimer associated with this IP packet.
Else (i.e., if enhanced discarding (or application frame/data unit (or PDU set) discarding) is not applicable for this DRB)
   AS discard this IP packet along with the corresponding Data PDU

Step 6. The ‘application layer info’ in the above description can be application layer frame info and/or application layer frame index and/or application layer data unit index/sequence number (e.g. PDU set sequence number) and/or time stamp at which application layer frame/data unit (or PDU set) is generated in application layer and/or application layer stream identity and/or traffic identifier. Based on this information UE can identify the packets or PDCP SDUs belonging to the same PDU set. The packets with same PDU set sequence number belongs to same PDU set.

Step 7. In an embodiment, ‘application layer info’ can be there in the header of packet received from upper layer.

In an embodiment, OPTIONS field in IP packet (e.g., time stamp (TS) and IMI traffic identifier or stream ID) can be the ‘application layer info’.

In another embodiment, ‘application layer info’ need not be explicitly embedded in the packet header, it can be provided via the interface between Application layer to TCP/IP, TCP/IP to NAS, NAS to AS.

In an embodiment, in the above procedure instead of ‘IP packet’, it can be any other protocol packet e.g., Ethernet packet, ATM packet, etc.

In an embodiment, all the procedures described herein can also be applied by GNB for downlink packets, with the following changes. Instead of upper layer (IP/NAS), gNB receives the IP packet and ‘application layer info’, QFI, PDU session ID associated with packet from UPF.

### Embodiment 2—Method and Apparatus for Logical Channel Prioritization

EXtended Reality (XR) is a term for different types of realities and refers to all real-and-virtual combined environments and human-machine interactions generated by computer technology and wearables. It includes following representative forms and the areas interpolated among them: Augmented Reality (AR); Mixed Reality (MR); Virtual Reality (VR).

In case of XR, it is important to transmit the packet within packet delay budget (PDB). Typical PDB is 10 ms for VR/CG UL stream. PDB is 10 ms or 30 ms for AR UL stream depending on type of stream. Logical channel (LCH) with lower PDB can have higher priority compared to LCH with higher PDB. However, if the LCH with higher PDB does not get scheduled, packet needs to be discarded after the PDB. The packet with higher PDB should get more priority as the remaining delivery time reduces.

So enhanced method of logical channel prioritization/uplink transmission is needed.

### [Method 2-1]

In an embodiment according to this method of disclosure, the operation is as follows:

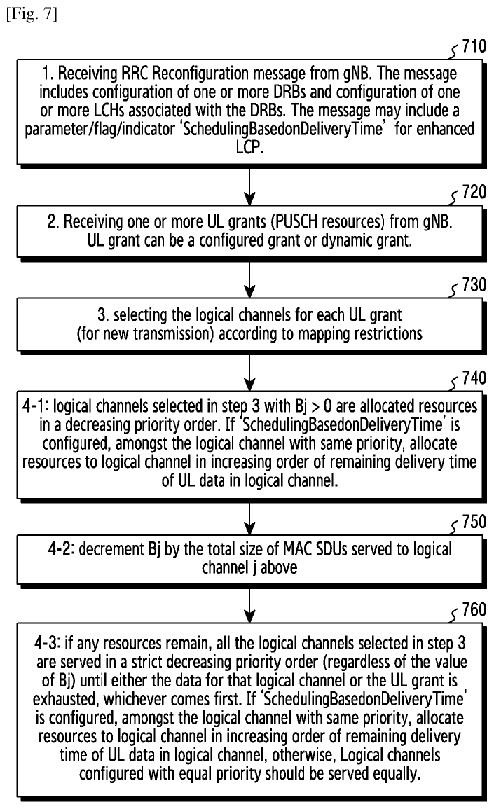

FIG. 7 illustrates an example of a flow chart for logical channel prioritization in accordance with an embodiment of the disclosure.

In 710, Step 1, UE receives RRC Reconfiguration message from gNB. The message includes configuration of one or more DRBs and configuration of one or more LCHs associated with the DRBs. The message may include mapping between logical channel and a subset of the configured cells, numerologies, PUSCH transmission durations, configured grant configurations and control whether a logical channel can utilize the resources allocated by a Type 1 Configured Grant or whether a logical channel can utilize dynamic grants indicating a certain physical priority level. The message may include a parameter/flag/indicator ‘SchedulingBasedonDeliveryTime’ (or EnhancedLCPEnabled, may also be known by some other name) for enhanced LCP (as explained later). UE may inform about its capability to support enhanced LCP or scheduling based on delivery time using UE assistance information message or some other message. The capability can be per UE. Alternately, capability can be per frequency range (FR) (e.g., FR1/FR2 etc.). Alternately capability can be per frequency band.

In 720, Step 2, UE receives one or more UL grants (PUSCH resources) from gNB. UL grant can be a configured grant or dynamic grant.

In 730, Step 3, UE select the logical channels for each UL grant (for new transmission) that satisfy all the following conditions:
the set of allowed Subcarrier Spacing index values in allowedSCS-List, if configured, includes the Subcarrier Spacing index associated to the UL grant; and
maxPUSCH-Duration, if configured, is larger than or equal to the PUSCH transmission duration associated to the UL grant; and
configuredGrantType1Allowed, if configured, is set to true in case the UL grant is a Configured Grant Type 1; and
allowedServingCells, if configured, includes the Cell information associated to the UL grant. Does not apply to logical channels associated with a DRB configured with PDCP duplication within the same MAC entity (i.e. CA duplication) when CA duplication is deactivated for this DRB in this MAC entity; and
allowedCG-List, if configured, includes the configured grant index associated to the UL grant; and
allowedPHY-PriorityIndex, if configured, includes the priority index associated to the dynamic UL grant.

The Subcarrier Spacing index, PUSCH transmission duration, Cell information, and priority index are included in Uplink transmission information received from gNB for the corresponding scheduled uplink transmission.

Step 4, UE shall for each UL grant (for new transmission), allocate resources to the logical channels as follows:

In 740, Step 4-1: logical channels selected in step 3 for the UL grant with Bj>0 are allocated resources in a decreasing priority order. If the PBR of a logical channel is set to infinity, the MAC entity shall allocate resources for all the data that is available for transmission on the logical channel before meeting the PBR of the lower priority logical channel(s). If ‘SchedulingBasedonDeliveryTime’ (or EnhancedLCPEnabled, may also be known by some other name) is configured, amongst the logical channel with same priority, allocate resources to logical channel in increasing order of remaining delivery time of UL data in logical channel.

In 750, Step 4-2: decrement Bj by the total size of MAC SDUs served to logical channel j above;

In 760, Step 4-3: if any resources remain, all the logical channels selected in step 3 are served in a strict decreasing priority order (regardless of the value of Bj) until either the data for that logical channel or the UL grant is exhausted, whichever comes first. If ‘SchedulingBasedonDeliveryTime’ (or EnhancedLCPEnabled, may also be known by some other name) is configured, amongst the logical channel with same priority, allocate resources to logical channel in increasing order of remaining delivery time of UL data in logical channel, otherwise, Logical channels configured with equal priority should be served equally.

In the above operation, remaining delivery time of UL data corresponding to a logical channel is the smallest remaining delivery time amongst all the UL data of that logical channel. In case where LCHs with PDB and LCHs without PDB exist together, then, we can regard the remaining delivery time of the LCHs without PDB as infinity. Remaining delivery time for a packet/data is basically ‘PDB—time elapsed since the data/packet arrived in buffer’ (e.g., PDCP buffer or L2 buffer). Note that PDCP SDU discard timer is started when data/packet arrived in PDCP buffer, so the remaining time of this discard timer can be considered as remaining delivery time. Alternately, remaining delivery time for a packet/data is basically ‘PDB—time elapsed since the data/packet arrived in NAS buffer’. Alternately, remaining delivery time for a packet/data is basically ‘PDB—time elapsed since the data/packet is generated by application layer’.

### [Method 2-1A]

In an embodiment according to this method of disclosure, the operation is as follows:

Step 1: UE receives RRC Reconfiguration message from gNB. The message includes configuration of one or more DRBs and configuration of one or more LCHs associated with the DRBs. The message may include mapping between logical channel and a subset of the configured cells, numerologies, PUSCH transmission durations, configured grant configurations and control whether a logical channel can utilize the resources allocated by a Type 1 Configured Grant or whether a logical channel can utilize dynamic grants indicating a certain physical priority level. The message may include a parameter/flag/indicator ‘SchedulingBasedonDeliveryTime’ (or EnhancedLCPEnabled, may also be known by some other name) for enhanced LCP (as explained later). UE may inform about its capability to support enhanced LCP or scheduling based on delivery time using UE assistance information message or some other message. The capability can be per UE. Alternately, capability can be per FR (FR1/FR2 etc.). Alternately capability can be per frequency band.

Step 2: UE receives one or more UL grants (PUSCH resources) from gNB. UL grant can be a configured grant or dynamic grant.

Step 3: UE select the logical channels for each UL grant (for new transmission) that satisfy all the following conditions:
the set of allowed Subcarrier Spacing index values in allowedSCS-List, if configured, includes the Subcarrier Spacing index associated to the UL grant; and
maxPUSCH-Duration, if configured, is larger than or equal to the PUSCH transmission duration associated to the UL grant; and
configuredGrantType1Allowed, if configured, is set to true in case the UL grant is a Configured Grant Type 1; and
allowedServingCells, if configured, includes the Cell information associated to the UL grant. Does not apply to logical channels associated with a DRB configured with PDCP duplication within the same MAC entity (i.e. CA duplication) when CA duplication is deactivated for this DRB in this MAC entity; and
allowedCG-List, if configured, includes the configured grant index associated to the UL grant; and
allowedPHY-PriorityIndex, if configured, includes the priority index associated to the dynamic UL grant.

The Subcarrier Spacing index, PUSCH transmission duration, Cell information, and priority index are included in Uplink transmission information received from gNB for the corresponding scheduled uplink transmission.

Step 4: UE shall for each UL grant (for new transmission), allocate resources to the logical channels as follows:

Step 4-1: logical channels selected in step 3 for the UL grant with Bj>0 are allocated resources in a decreasing priority order. If the PBR of a logical channel is set to infinity, the MAC entity shall allocate resources for all the data that is available for transmission on the logical channel before meeting the PBR of the lower priority logical channel(s). If ‘SchedulingBasedonDeliveryTime’ (or EnhancedLCPEnabled, may also be known by some other name) is configured and UL grant is for a specific service X/XR indicator, amongst the logical channel with same priority, allocate resources to logical channel in increasing order of remaining delivery time of UL data in logical channel.

Step 4-2: decrement Bj by the total size of MAC SDUs served to logical channel j above;

Step 4-3: if any resources remain, all the logical channels selected in step 3 are served in a strict decreasing priority order (regardless of the value of Bj) until either the data for that logical channel or the UL grant is exhausted, whichever comes first. If ‘SchedulingBasedonDeliveryTime’ (or EnhancedLCPEnabled, may also be known by some other name) is configured and UL grant is for a specific service X/XR indicator, amongst the logical channel with same priority, allocate resources to logical channel in increasing order of remaining delivery time of UL data in logical channel, otherwise, Logical channels configured with equal priority should be served equally.

In the above operation, remaining delivery time of UL data corresponding to a logical channel is the smallest remaining delivery time amongst all the UL data of that logical channel. In case where LCHs with PDB and LCHs without PDB exist together, then, we can regard the remaining delivery time of the LCHs without PDB as infinity. Remaining delivery time for a packet/data is basically ‘PDB—time elapsed since the data/packet arrived in buffer (e.g., PDCP buffer or L2 buffer)’. Note that PDCP SDU discard timer is started when data/packet arrived in PDCP buffer, so the remaining time of this discard timer can be considered as remaining delivery time. Alternately, remaining delivery time for a packet/data is basically ‘PDB—time elapsed since the data/packet arrived in NAS buffer’. Alternately, remaining delivery time for a packet/data is basically ‘PDB—time elapsed since the data/packet is generated by application layer’.

### [Method 2-2]

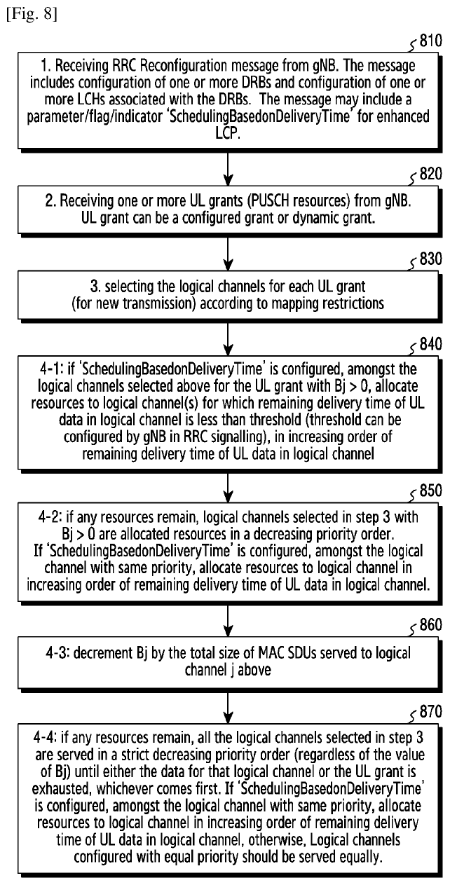

FIG. 8 illustrates another example of a flow chart for logical channel prioritization in accordance with an embodiment of the disclosure.

In an embodiment according to this method of disclosure, the operation is as follows:

In 810, Step 1: UE receives RRC Reconfiguration message from gNB. The message includes configuration of one or more DRBs and configuration of one or more LCHs associated with the DRBs. The message may include mapping between logical channel and a subset of the configured cells, numerologies, PUSCH transmission durations, configured grant configurations and control whether a logical channel can utilize the resources allocated by a Type 1 Configured Grant or whether a logical channel can utilize dynamic grants indicating a certain physical priority level. The message may include a parameter/flag/indicator ‘SchedulingBasedonDeliveryTime’ (or EnhancedLCPEnabled, may also be known by some other name) for enhanced LCP (as explained later). UE may inform about its capability to support enhanced LCP or scheduling based on delivery time using UE assistance information message or some other message. The capability can be per UE. Alternately, capability can be per FR (FR1/FR2 etc.). Alternately capability can be per frequency band.

In 820, Step 2: UE receives one or more UL grants (PUSCH resources) from gNB. UL grant can be a configured grant or dynamic grant.

In 830, Step 3: UE select the logical channels for each UL grant (for new transmission) that satisfy all the following conditions:
the set of allowed Subcarrier Spacing index values in allowedSCS-List, if configured, includes the Subcarrier Spacing index associated to the UL grant; and
maxPUSCH-Duration, if configured, is larger than or equal to the PUSCH transmission duration associated to the UL grant; and
configuredGrantType1Allowed, if configured, is set to true in case the UL grant is a Configured Grant Type 1; and
allowedServingCells, if configured, includes the Cell information associated to the UL grant. Does not apply to logical channels associated with a DRB configured with PDCP duplication within the same MAC entity (i.e. CA duplication) when CA duplication is deactivated for this DRB in this MAC entity; and
allowedCG-List, if configured, includes the configured grant index associated to the UL grant; and
allowedPHY-PriorityIndex, if configured, includes the priority index associated to the dynamic UL grant.

The Subcarrier Spacing index, PUSCH transmission duration, Cell information, and priority index are included in Uplink transmission information received from gNB for the corresponding scheduled uplink transmission.

Step 4: UE shall for each UL grant (for new transmission), allocate resources to the logical channels as follows:
In 840, Step 4-1: if ‘SchedulingBasedonDeliveryTime’ (or EnhancedLCPEnabled, may also be known by some other name) is configured, amongst the logical channels selected in step 3 for the UL grant with Bj>0, allocate resources to logical channel(s) for which remaining delivery time of UL data in logical channel is less than threshold (threshold can be configured by gNB in RRC signalling), in increasing order of remaining delivery time of UL data in logical channel;
In 850, Step 4-2: if any resources remain, logical channels selected in step 3 for the UL grant with Bj>0 are allocated resources in a decreasing priority order. If the PBR of a logical channel is set to infinity, the MAC entity shall allocate resources for all the data that is available for transmission on the logical channel before meeting the PBR of the lower priority logical channel(s). If ‘SchedulingBasedonDeliveryTime’ (or EnhancedLCPEnabled, may also be known by some other name) is configured, amongst the logical channel with same priority, allocate resources to logical channel in increasing order of remaining delivery time of UL data in logical channel.

In 860, Step 4-3: decrement Bj by the total size of MAC SDUs served to logical channel j above;

In 870, Step 4-4: if any resources remain, all the logical channels selected in step 3 are served in a strict decreasing priority order (regardless of the value of Bj) until either the data for that logical channel or the UL grant is exhausted, whichever comes first. If ‘SchedulingBasedonDeliveryTime’ (or EnhancedLCPEnabled, may also be known by some other name) is configured, amongst the logical channel with same priority, allocate resources to logical channel in increasing order of remaining delivery time of UL data in logical channel, otherwise, Logical channels configured with equal priority should be served equally.

In the above operation, remaining delivery time of UL data corresponding to a logical channel is the smallest remaining delivery time amongst all the UL data of that logical channel. In case where LCHs with PDB and LCHs without PDB exist together, then, we can regard the remaining delivery time of the LCHs without PDB as infinity. Remaining delivery time for a packet/data is basically ‘PDB—time elapsed since the data/packet arrived in buffer (e.g., PDCP buffer or L2 buffer)’. Note that PDCP SDU discard timer is started when data/packet arrived in PDCP buffer, so the remaining time of this discard timer can be considered as remaining delivery time. Alternately, remaining delivery time for a packet/data is basically ‘PDB—time elapsed since the data/packet arrived in NAS buffer.’ Alternately, remaining delivery time for a packet/data is basically ‘PDB—time elapsed since the data/packet is generated by application layer’.

### [Method 2-2A]

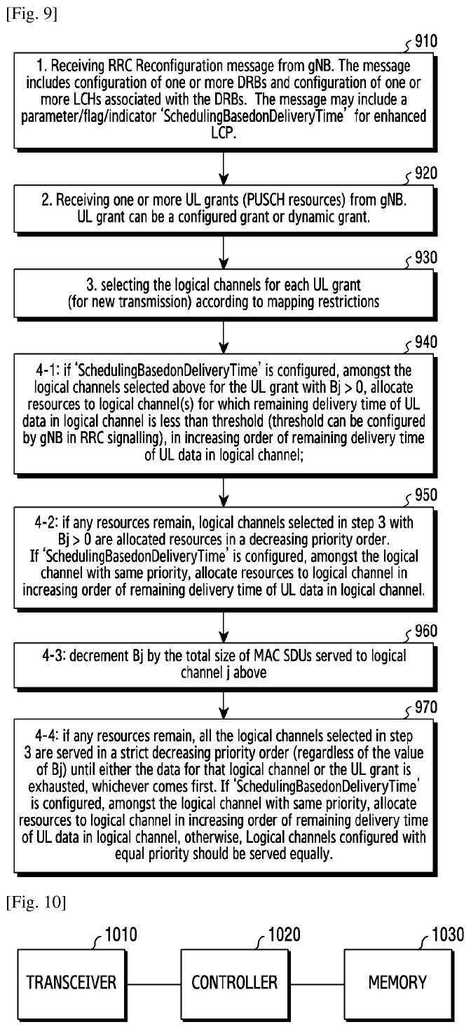

FIG. 9 illustrates another example of a flow chart for logical channel prioritization in accordance with an embodiment of the disclosure.

In an embodiment according to this method of disclosure, the operation is as follows:

In 910, Step 1: UE receives RRC Reconfiguration message from gNB. The message includes configuration of one or more DRBs and configuration of one or more LCHs associated with the DRBs. The message may include mapping between logical channel and a subset of the configured cells, numerologies, PUSCH transmission durations, configured grant configurations and control whether a logical channel can utilize the resources allocated by a Type 1 Configured Grant or whether a logical channel can utilize dynamic grants indicating a certain physical priority level. The message may include a parameter/flag/indicator ‘SchedulingBasedonDeliveryTime’ (or EnhancedLCPEnabled, may also be known by some other name) for enhanced LCP (as explained later). UE may inform about its capability to support enhanced LCP or scheduling based on delivery time using UE assistance information message or some other message. The capability can be per UE. Alternately, capability can be per FR (FR1/FR2 etc.). Alternately capability can be per frequency band.

In 920, Step 2: UE receives one or more UL grants (PUSCH resources) from gNB. UL grant can be a configured grant or dynamic grant.

In 930, Step 3: UE select the logical channels for each UL grant (for new transmission) that satisfy all the following conditions:
the set of allowed Subcarrier Spacing index values in allowedSCS-List, if configured, includes the Subcarrier Spacing index associated to the UL grant; and
maxPUSCH-Duration, if configured, is larger than or equal to the PUSCH transmission duration associated to the UL grant; and
configuredGrantType1Allowed, if configured, is set to true in case the UL grant is a Configured Grant Type 1; and
allowedServingCells, if configured, includes the Cell information associated to the UL grant. Does not apply to logical channels associated with a DRB configured with PDCP duplication within the same MAC entity (i.e. CA duplication) when CA duplication is deactivated for this DRB in this MAC entity; and
allowedCG-List, if configured, includes the configured grant index associated to the UL grant; and
allowedPHY-PriorityIndex, if configured, includes the priority index associated to the dynamic UL grant.

The Subcarrier Spacing index, PUSCH transmission duration, Cell information, and priority index are included in Uplink transmission information received from gNB for the corresponding scheduled uplink transmission.

Step 4: UE shall for each UL grant (for new transmission), allocate resources to the logical channels as follows:
In 940, Step 4-1: if ‘SchedulingBasedonDeliveryTime’ (or EnhancedLCPEnabled, may also be known by some other name) is configured and UL grant is for service X/XR indicator, amongst the logical channels selected in step 3 for the UL grant with Bj>0, allocate resources to logical channel(s) for which remaining delivery time of UL data in logical channel is less than threshold (threshold can be configured by gNB in RRC signalling), in increasing order of remaining delivery time of UL data in logical channel;
In 950, Step 4-2: if any resources remain, logical channels selected in step 3 for the UL grant with Bj>0 are allocated resources in a decreasing priority order. If the PBR of a logical channel is set to infinity, the MAC entity shall allocate resources for all the data that is available for transmission on the logical channel before meeting the PBR of the lower priority logical channel(s). If ‘SchedulingBasedonDeliveryTime’ (or EnhancedLCPEnabled, may also be known by some other name) is configured and UL grant is for service X/XR indicator, amongst the logical channel with same priority, allocate resources to logical channel in increasing order of remaining delivery time of UL data in logical channel.

In 960, Step 4-3: decrement Bj by the total size of MAC SDUs served to logical channel j above;

In 970, Step 4-4: if any resources remain, all the logical channels selected in step 3 are served in a strict decreasing priority order (regardless of the value of Bj) until either the data for that logical channel or the UL grant is exhausted, whichever comes first. If ‘SchedulingBasedonDeliveryTime’ (or EnhancedLCPEnabled, may also be known by some other name) is configured and UL grant is for service X/XR indicator, amongst the logical channel with same priority, allocate resources to logical channel in increasing order of remaining delivery time of UL data in logical channel, otherwise, Logical channels configured with equal priority should be served equally.

In the above operation, remaining delivery time of UL data corresponding to a logical channel is the smallest remaining delivery time amongst all the UL data of that logical channel. In case where LCHs with PDB and LCHs without PDB exist together, then, we can regard the remaining delivery time of the LCHs without PDB as infinity. Remaining delivery time for a packet/data is basically ‘PDB—time elapsed since the data/packet arrived in buffer (e.g., PDCP buffer or L2 buffer)’. Note that PDCP SDU discard timer is started when data/packet arrived in PDCP buffer, so the remaining time of this discard timer can be considered as remaining delivery time. Alternately, remaining delivery time for a packet/data is basically ‘PDB—time elapsed since the data/packet arrived in NAS buffer’. Alternately, remaining delivery time for a packet/data is basically ‘PDB—time elapsed since the data/packet is generated by application layer.’

In an alternate embodiment of method 2-1/2-1A/2-2/2-2A, network i.e., gNB can indicate (in PDCCH or RRC signaling) that UL grant is for service X/XR indicator/any other name. LCHs associated with service X/XR indicator/any other name are indicated in RRC signaling by including service indicator/XR indicator/any other name in LCH/DRB config.

In an alternate embodiment, the modifications in LCP (as explained earlier) are applied only if the UL grant is for service X/XR indicator/, otherwise legacy LCP applies.

### [Method 2-3]

In an embodiment according to this method of disclosure, the operation is as follows:

Step 1: UE receives RRC Reconfiguration message from gNB. The message includes configuration of one or more DRBs and configuration of one or more LCHs associated with the DRBs. The message may include mapping between logical channel and a subset of the configured cells, numerologies, PUSCH transmission durations, configured grant configurations and control whether a logical channel can utilize the resources allocated by a Type 1 Configured Grant or whether a logical channel can utilize dynamic grants indicating a certain physical priority level. LCHs associated with service X/XR indicator/any other name are indicated in RRC signaling by including service indicator/XR indicator/any other name in LCH/DRB config

Step 2: UE receives one or more UL grants (PUSCH resources) from gNB for service X/XR indicator (can also be referred by any other name). UL grant can be a configured grant or dynamic grant.

Step 3: UE select the logical channels for each UL grant (for new transmission) as follows:
the set of allowed Subcarrier Spacing index values in allowedSCS-List, if configured, includes the Subcarrier Spacing index associated to the UL grant; and
maxPUSCH-Duration, if configured, is larger than or equal to the PUSCH transmission duration associated to the UL grant; and
configuredGrantType1Allowed, if configured, is set to true in case the UL grant is a Configured Grant Type 1; and
allowedServingCells, if configured, includes the Cell information associated to the UL grant. Does not apply to logical channels associated with a DRB configured with PDCP duplication within the same MAC entity (i.e. CA duplication) when CA duplication is deactivated for this DRB in this MAC entity; and
allowedCG-List, if configured, includes the configured grant index associated to the UL grant; and
allowedPHY-PriorityIndex, if configured, includes the priority index associated to the dynamic UL grant; and
service X/XR indicator, if configured, in case the UL grant is for service X/XR indicator

The Subcarrier Spacing index, PUSCH transmission duration, Cell information, and priority index are included in Uplink transmission information received from gNB for the corresponding scheduled uplink transmission.

Step 4: UE shall for each UL grant (for new transmission), allocate resources to the logical channels as follows:

Step 4-1: logical channels selected in step 3 for the UL grant with Bj>0 are allocated resources in a decreasing priority order. If the PBR of a logical channel is set to infinity, the MAC entity shall allocate resources for all the data that is available for transmission on the logical channel before meeting the PBR of the lower priority logical channel(s).

Step 4-2: decrement Bj by the total size of MAC SDUs served to logical channel j above;

Step 4-3: if any resources remain, all the logical channels selected in step 3 are served in a strict decreasing priority order (regardless of the value of Bj) until either the data for that logical channel or the UL grant is exhausted, whichever comes first.

In the above operation, remaining delivery time of UL data corresponding to a logical channel is the smallest remaining delivery time amongst all the UL data of that logical channel. In case where LCHs with PDB and LCHs without PDB exist together, then, we can regard the remaining delivery time of the LCHs without PDB as infinity. Remaining delivery time for a packet/data is basically ‘PDB—time elapsed since the data/packet arrived in buffer (e.g., PDCP buffer or L2 buffer)’. Note that PDCP SDU discard timer is started when data/packet arrived in PDCP buffer, so the remaining time of this discard timer can be considered as remaining delivery time. Alternately, remaining delivery time for a packet/data is basically ‘PDB—time elapsed since the data/packet arrived in NAS buffer’. Alternately, remaining delivery time for a packet/data is basically ‘PDB—time elapsed since the data/packet is generated by application layer’.

FIG. 10 is a block diagram of a terminal according to an embodiment of the disclosure.

Referring to FIG. 10, a terminal includes a transceiver 1010, a controller 1020 and a memory 1030. The controller 1020 may refer to a circuitry, an application-specific integrated circuit (ASIC), or at least one processor. The transceiver 1010, the controller 1020 and the memory 1030 are configured to perform the operations of the UE illustrated in the figures, e.g., FIGS. 1 to 9, or described above. Although the transceiver 1010, the controller 1020 and the memory 1030 are shown as separate entities, they may be realized as a single entity like a single chip. Or, the transceiver 1010, the controller 1020 and the memory 1030 may be electrically connected to or coupled with each other.

The transceiver 1010 may transmit and receive signals to and from other network entities, e.g., a base station. The controller 1020 may control the UE to perform functions according to one of the embodiments described above.

In an embodiment, the operations of the terminal may be implemented using the memory 1030 storing corresponding program codes. Specifically, the terminal may be equipped with the memory 1030 to store program codes implementing desired operations. To perform the desired operations, the controller 1020 may read and execute the program codes stored in the memory 1030 by using a processor or a central processing unit (CPU).

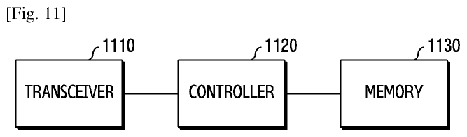

FIG. 11 is a block diagram of a base station according to an embodiment of the disclosure.

Referring to FIG. 11, a base station includes a transceiver 1110, a controller 1120 and a memory 1130. The transceiver 1110, the controller 1120 and the memory 1130 are configured to perform the operations of the network (e.g., gNB) illustrated in the figures, e.g., FIGS. 1 to 9, or described above. Although the transceiver 1110, the controller 1120 and the memory 1130 are shown as separate entities, they may be realized as a single entity like a single chip. The transceiver 1110, the controller 1120 and the memory 1130 may be electrically connected to or coupled with each other.

The transceiver 1110 may transmit and receive signals to and from other network entities, e.g., a terminal. The controller 1120 may control the base station to perform functions according to one of the embodiments described above. In an embodiment, the operations of the base station may be implemented using the memory 1130 storing corresponding program codes. Specifically, the base station may be equipped with the memory 1130 to store program codes implementing desired operations. To perform the desired operations, the controller 1120 may read and execute the program codes stored in the memory 1130 by using a processor or a CPU.

While the disclosure has been shown and described with reference to various embodiments thereof, it will be understood by those skilled in the art that various changes in form and details may be made therein without departing from the spirit and scope of the disclosure as defined by the appended claims and their equivalents.

As described above, embodiments disclosed in the specification and drawings are merely used to present specific examples to easily explain the contents of the disclosure and to help understanding, but are not intended to limit the scope of the disclosure. Accordingly, the scope of the disclosure should be analyzed to include all changes or modifications derived based on the technical concept of the disclosure in addition to the embodiments disclosed herein.

1-15. (canceled)

16. A method performed by a terminal in a wireless communication system, the method comprising:
receiving, from a base station, first information configuring a packet data convergence protocol (PDCP) entity; and
in case that a discard timer expires for a PDCP service data unit (SDU) and second information indicating the terminal to perform a protocol data unit (PDU) set based discarding for the PDCP entity is configured in the first information, discarding all PDCP SDUs belonging to a PDU set to which the PDCP SDU belongs along with corresponding PDCP data PDUs.

17. The method of claim 16, further comprising:
in case that a corresponding PDCP data PDU has been submitted to a lower layer, indicating the discarding to the lower layer.

18. The method of claim 16, further comprising:
in case that the discard timer expires for the PDCP SDU and the second information is not configured in the first information, discarding the PDCP SDU along with a corresponding PDCP data PDU.

19. The method of claim 16, further comprising:
receiving, from the base station, a capability enquiry message; and
transmitting, to the base station, a capability information message comprising capability information indicating that the terminal supports the PDU set based discarding,
wherein the information indicating the terminal to perform the PDCP set based discarding is included in a radio resource control (RRC) reconfiguration message.

20. A method performed by a base station in a wireless communication system, the method comprising:
transmitting, to a terminal, first information configuring a packet data convergence protocol (PDCP) entity,
wherein, in case that a discard timer expires for a PDCP service data unit (SDU) and second information indicating the terminal of a protocol data unit (PDU) set based discarding for the PDCP entity is configured in the first information, all PDCP SDUs belonging to a PDU set to which the PDCP SDU belongs are discarded along with corresponding PDCP data PDUs.

21. The method of claim 20,
wherein, in case that a corresponding PDCP data PDU has been submitted to a lower layer, the discarding is indicated to the lower layer, and
wherein, in case that the discard timer expires for the PDCP SDU and the second information is not configured in the first information, the PDCP SDU is discarded along with a corresponding PDCP data PDU.

22. The method of claim 20, further comprising:
transmitting, to the terminal, a capability enquiry message; and
receiving, from the terminal, a capability information message comprising capability information indicating that the terminal supports the PDU set based discarding,
wherein the information indicating the terminal to perform the PDCP set based discarding is included in a radio resource control (RRC) reconfiguration message.

23. A terminal in a wireless communication system, the terminal comprising:
a transceiver; and
a controller coupled with the transceiver and configured to:
receive, from a base station, first information configuring a packet data convergence protocol (PDCP) entity, and
in case that a discard timer expires for a PDCP service data unit (SDU) and second information indicating the terminal to perform a protocol data unit (PDU) set based discarding for the PDCP entity is configured in the first information, discarding all PDCP SDUs belonging to a PDU set to which the PDCP SDU belongs along with corresponding PDCP data PDUs.

24. The terminal of claim 23, wherein the controller is further configured to:
in case that a corresponding PDCP data PDU has been submitted to a lower layer, indicate the discarding to the lower layer.

25. The terminal of claim 23, wherein the controller is further configured to:
in case that the discard timer expires for the PDCP SDU and the second information is not configured in the first information, discard the PDCP SDU along with a corresponding PDCP data PDU.

26. The terminal of claim 23, wherein the controller is further configured to:
receive, from the base station, a capability enquiry message, and
transmit, to the base station, a capability information message comprising capability information indicating that the terminal supports the PDU set based discarding,
wherein the information indicating the terminal to perform the PDCP set based discarding is included in a radio resource control (RRC) reconfiguration message.

27. A base station in a wireless communication system, the base station comprising:
a transceiver; and
a controller coupled with the transceiver and configured to:
transmit, to a terminal, first information configuring a packet data convergence protocol (PDCP) entity,
wherein, in case that a discard timer expires for a PDCP service data unit (SDU) and second information indicating the terminal of a protocol data unit (PDU) set based discarding for the PDCP entity is configured in the first information, all PDCP SDUs belonging to a PDU set to which the PDCP SDU belongs are discarded along with corresponding PDCP data PDUs.

28. The base station of claim 27, wherein, in case that a corresponding PDCP data PDU has been submitted to a lower layer, the discarding is indicated to the lower layer.

29. The base station of claim 27, wherein, in case that the discard timer expires for the PDCP SDU and the second information is not configured in the first information, the PDCP SDU is discarded along with a corresponding PDCP data PDU.

30. The base station of claim 27, wherein the controller is further configured to:
transmit, to the terminal, a capability enquiry message, and
receive, from the terminal, a capability information message comprising capability information indicating that the terminal supports the PDU set based discarding,
wherein the information indicating the terminal to perform the PDCP set based discarding is included in a radio resource control (RRC) reconfiguration message.
